(19) United States
(12) Patent Application Publication
(10) Pub. No.: US 2004/0022130 A1
(43) Pub. Date: Feb. 5, 2004

(54) Multifunction wristwatch

(76) Inventor: Yi Shing Chung, Hong Kong (HK)

Correspondence Address: NATH & ASSOCIATES, 1030 15th STREET, 6TH FLOOR, WASHINGTON, DC, 20005, US

(21) Appl. No.: 10/377,761

(22) Filed: Mar. 4, 2003

(30) Foreign Application Priority Data
Aug. 5, 2002 (CN) 02243443.7

(51) Int. Cl. G04B 47/00

(52) U.S. Cl. 368/10

(57) ABSTRACT

A kind of multifunction wristwatch, wherein it comprises MP3 playing device and watch, in which the MP3 playing device is disposed inside the watch, the said watch is the electric watch, which is consisted of housing, time displaying circuit, displaying screen and watch belt; the said MP3 playing device is consisted of control button, playing control circuit and the memory, in which the control button is disposed on the housing and is connected with the playing control circuit; the playing control circuit is also connected with the memory and disposed on the circuit board in the housing being provided with the USB interface which could be connected with the charging circuit and the ear-phone. Therefor the present utility model has the advantages of charming appearance, small size, easy to carry and operate, convenient for charging and with multi-functions.

### THE TECHNICAL FIELD

The present utility model relates to the mechanical and electric field, and more particularly relates to one kind of multifunction wristwatch.

### THE BACKGROUND ART

With the development of the information, the people's consuming idea have made a great change, the more and more digital movable music products with small interfaceable size have got people's favor, such as the MP3 player, however, many same kinds products have the shortcoming of simplex function and appearance, lower transmission speed, high electric consumption, environmental pollution and not easy to carry, and also the requirement by people concerning the wristwatch has improved a lot by not only focusing on its time displaying function, which results producing more and more multifunction wristwatches, but most of them are only the combined products of the general electric product with the wristwatch, but without combing the most favorable musical MP3 player with the wristwatch.

### THE INVENTIVE CONTENT

The purpose of the present utility model is to provide a kind of multifunction wristwatch, which could provide the convenient MP3 playing function.

The purpose of the present utility model is realized by the following technical scheme:

A kind of multifunction wristwatch, it comprises MP3 playing device and watch, in which the MP3 playing device is disposed inside the watch.

The said watch is the electric watch, which is consisted of housing, time displaying circuit, displaying screen and watch belt; the said displaying screen is on the housing, and the said watch belt is connected with the two sides of the housing respectively, the time displaying circuit is disposed in the housing.

The said time displaying circuit includes the clock displaying circuit and the calendar displaying circuit.

The said MP3 playing device is consisted of control button, playing control circuit and the memory, in which the control button is disposed on the housing and is connected with the playing control circuit; the playing control circuit is also connected with the memory and disposed on the circuit board in the housing being provided with the USB interface.

The power supply part of the playing control circuit is the rechargeable environmental protection lithium battery whose charging circuit is connected to the outside charging circuit through the USB interface.

The audio playing part of the playing control circuit is connected to the outside speaker through the USB interface.

There is recording circuit being disposed inside the said housing, the recording circuit collects tie voice information through the mike and is connected with the memory.

It could be seen from the above technical scheme, the multifunction wristwatch of the present utility model not only maintains the all functions of the common electric wristwatch, but also combines the functions of playing MP3 music,digital recording and electric movable hard disk, the user could download the different kinds files in the MP3 format on his MP3 player for enjoying, in addition, the present product could also be used as digital recorder which could download the recorded video or audio files to his computer for playing or sending the E-mail. Therefor the present utility model has the advantages of charming appearance small size, easy to carry and operate, convenient for charging and with multi-functions. The USB interface of this utility model is advantageous for not only transmitting the downloaded data through the said USB interface and getting power supply from the computer (or AC power source), but also inserting ear-phone from the interface.

### THE SPECIFICATION OF THE DRAWINGS

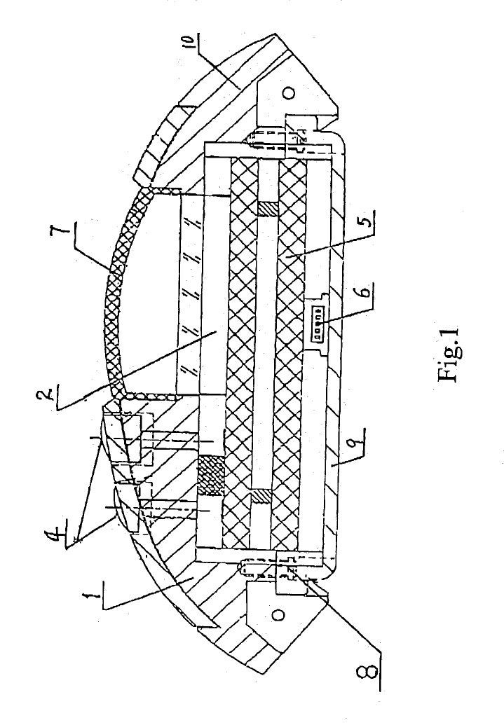

The FIG. 1 is the structural view of the present utility model;

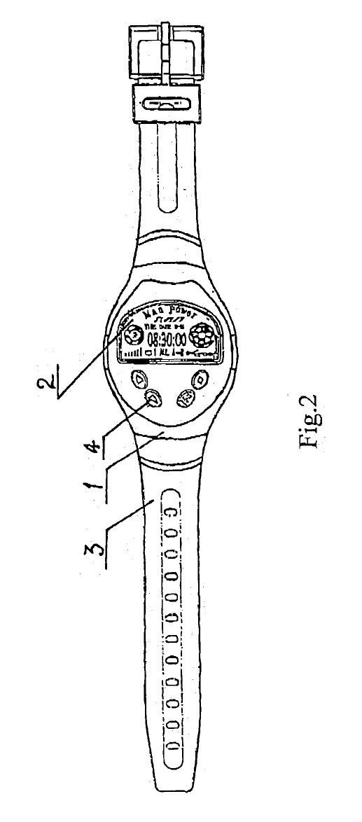

The FIG. 2 is also the structural view of the present utility model;

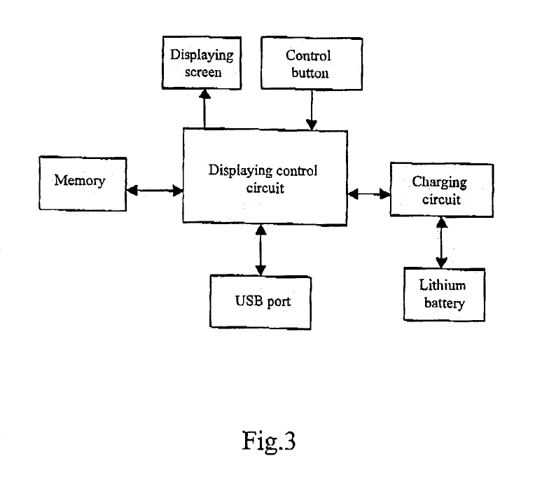

The FIG. 3 is the inner circuit diagram of the present utility model.

### THE PREFERRED EMBODIMENTS

The following specification is mainly concerned about the specific embodiments of the multifunction wristwatch of the present utility model. Referring to the FIG. 1 and FIG. 2, the wristwatch of the present utility model includes MP3 playing device and watch, in which the MP3 playing device is disposed inside the watch, the said watch is the electric watch, which is consisted of housing 1, time displaying circuit, displaying screen 2 and watch belt 3; the said displaying screen 2 is on the housing 1, and the displaying screen 2 is the LCD displaying screen, on which the transparent case 7 being disposed; and the said watch belt 3 is connected with the two sides of the housing 1 respectively, the time displaying circuit is disposed in the housing 1, the said time displaying circuit includes the clock displaying circuit and the calendar displaying circuit) which supply the clock function and the calendar function to the user; the time displaying circuit may be supplied directly by the MP3 playing device or being supplied independently.

The said housing 1 includes the upper housing 10 and the lower housing 9 which being connected with the screw 8, the circuit board 5 is disposed and mounted inside the housing 1.

As shown in FIG. 3, the said MP3 playing device is consisted of control button 4, playing control circuit and the memory, in which the control button 4 is in the number of four and disposed on the housing 1 and is connected with the playing control circuit for controlling the playing; the playing control circuit is also connected with the memory in which for storing the audio files to be played, and the memory could also be used as a common memory for storing other information for the user, in order to be convenient for the user to carry the data which is in the function as the moving harddisk; the playing control circuit is disposed on the circuit board 5 in the housing 1 and being provided with the USB interface 6 which located on the lower housing, the user could store the different data information in the memory of the playing control circuit, and also could transfer the data information stored in the memory to the other storing devices; the playing control circuit is also connected with the displaying screen 2 of the electric wristwatch for displaying part of the playing control information on the displaying screen 2.

The power supply part of the playing control circuit is the rechargeable environmental protection lithium battery whose charging circuit is connected to the outside charging circuit through the USB interface 6; the outside charging circuit may obtain the power supply from the computer and also could be connected to the AC power supply directly, that is to get the electric energy from the AC power supply through the charger with the USB interface.

The audio playing part of the playing control circuit is connected to the outside speaker through the USB interface 6.

There is recording circuit being disposed inside the said housing 1, the recording circuit collects the voice information through the mike and is connected with the memory, the recording information could be stored in the memory in order for use or for transferring to other storing devices, such as uploading the recording information into the memory of the computer, and also could be sent outside through the E-mail.

1. A kind of multifunction wristwatch, wherein it comprises MP3 playing device and watch, in which the said MP3 playing device is disposed inside the said watch.

2. The multifunction wristwatch according to the claim 1, wherein the said watch is the electric watch, which is consisted of housing (1), time displaying circuit, displaying screen (2) and watch belt (3); the said displaying screen (2) is on the housing (1),and the said watch belt (3) is connected with the two sides of the housing (1) respectively, the time displaying circuit is disposed in the housing (1).

3. The multifunction wristwatch according to the claim 2, wherein the said time displaying circuit includes the clock displaying circuit and the calendar displaying circuit.

4. The multifunction wristwatch according to the claim 2, wherein the said MP3 playing device is consisted of control button (4),playing control circuit and the memory, in which the control button(4) is disposed on the housing (1) and is connected with the playing control circuit; the playing control circuit is also connected with the memory and disposed on the circuit board (5) in the housing (1) being provided with the USB interface.

5. The multifunction wristwatch according to the claim 4, wherein the power supply part of the playing control circuit is the rechargeable environmental protection lithium, battery whose charging circuit is connected to the outside charging circuit through the USB interface.

6. The multifunction wristwatch according to the claim 4, wherein the audio playing part of the playing control circuit is connected to the outside speaker through the USB interface. 7. The multifunction wristwatch according to the claim 4, wherein there is recording circuit being disposed inside the said housing (1), the recording circuit collects the voice information through the mike and is connected with the memory.
